(19) United States
(12) Patent Application Publication
(10) Pub. No.: US 2007/0280280 A1
(43) Pub. Date: Dec. 6, 2007

(54) Resource allocation for grouped resource units

(75) Inventors: Frank Frederiksen, Klarup (DK); Troels Kolding, Klarup (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/594,139

(22) Filed: Nov. 8, 2006

(30) Foreign Application Priority Data
Jun. 2, 2006 (EP) 06011531.8

(51) Int. Cl. H04L 12/28

(52) U.S. Cl. 370/431

(57) ABSTRACT

The present invention relates to a method, apparatus and computer program product for allocating resource units to a plurality of users in a multiplex transmission system. A transmission quality of available resource units to be allocated is determined for each user, and the resource unit with the highest transmission quality is allocated to the respective strongest user for which the highest transmission quality has been determined. An allocation range of the strongest user is expanded by allocating adjacent resource units to the strongest user as long as the determined transmission quality of the adjacent resource units is still the highest. Resource units with highest transmission quality among the remaining resource units are allocated to the respective remaining users and their allocation ranges are expanded as long as transmission quality of the adjacent resource units is still the highest among the remaining resource units.

### FIELD OF THE INVENTION

The present invention relates to a method, system, network element and network management device for allocating resource units to a plurality of users in a multiplex transmission system.

### BACKGROUND OF THE INVENTION

In future wireless systems, such as the upcoming Universal Mobile Telecommunications System (UMTS) Terrestrial Radio Access Networks (UTRAN) Long Term Evolution (LTE), resource allocation by packet scheduling will become a critical issue, as it will mainly determine system and user performance. The scheduler functionality has a complex task of managing quality of service (QoS) requests ranging from real-time to best effort delivery, while maintaining high system capacity.

Most recent generations of broadband wireless systems employ multi-carrier transmission in downlink direction from network side to terminal side. In these systems it is desirable to multiplex users in the frequency domain for several reasons, such as providing frequency bands with good channel conditions to users and optimizing channel utilization in view of the fact that some users may not have enough data to utilize the complete bandwidth (e.g. VoIP etc.). If users are given the flexibility to be allocated to any of the available multi-carriers, this may however involve heavy signalling load in the downlink direction for informing users about the carriers which have been allocated to them. Thus, it is has been suggested in practice that only adjacent sub-carriers can be allocated to individual users. While this simplifies the signalling, it imposes additional complexity to frequency domain packet scheduling which is needed to achieve very high capacity. The optimization problem is now a constrained one, which does not allow simple sorting of users on a per sub-carrier or on a per group of sub-carriers basis.

From a performance perspective, full allocation flexibility can be used to provide extra gain in the network transmission capacity when employing resource allocation mechanisms, such as frequency domain packet scheduling (FDPS). However—as already mentioned above—due to signalling complexity, only adjacent resource units (e.g. sub-carriers) may be allocated to individual users. While this prevents the use of an optimum allocation or scheduling procedure, it imposes higher complexity on the allocation or scheduling processing. An optimum search within the available combinations gets out of hand very quickly, even with a small amount of users (say 5-6).

### SUMMARY OF THE INVENTION

It is therefore an object of the present invention to provide an allocation mechanism for grouped or adjacent resource units, by means of which signaling and processing requirements can be reduced.

This object is achieved by a method of allocating resource units to a plurality of users in a multiplex transmission system, said method comprising the steps of:
determining for each user a transmission quality of available resource units to be allocated;
allocating the resource unit with the highest transmission quality to the respective strongest user for which the highest transmission quality has been determined;
expanding an allocation range of said strongest user by allocating adjacent resource units to said strongest user as long as the determined transmission quality of said adjacent resource units is still the highest; and
successively allocating resource units with highest transmission quality among the remaining resource units to the respective remaining users and expanding their allocation ranges as long as transmission quality of said adjacent resource units is still the highest among the remaining resource units.

Additionally, the above object is achieved by an apparatus, e.g. base station device in a wireless system, for allocating resource units to a plurality of users in a multiplex transmission system, wherein the apparatus is configured to perform an allocation method according to the above steps.

The functionalities of the present invention can be implemented as a computer program product comprising code means for generating the generating the above method steps when run on a computer device.

Accordingly, a sub-optimum resource allocation approach is provided, which is computationally much simpler than doing exhaustive search and produces better performance than simple sorted algorithms. With the help of this solution, under normal operating conditions, a system capacity of only 5-10% lower than the maximum potential achieved with exhaustive search can be achieved (but still under the constraint that the resources given to a single user should be adjacent). Even for a large number of resource units, e.g. frequency pools, and users, the iterative procedure provides very fast results.

A checking may be performed as to whether the obtained allocation allows for previously allocated allocation ranges to be expanded, and expandable allocation ranges may then be expanded starting from said strongest user.

Each resource unit may correspond to a sub-carrier of a multi-carrier transmission system. The resource allocation may be used for frequency domain packet scheduling in a downlink transmission of a wireless system.

Additionally, the transmission quality may be determined based on a signal-to-noise-plus-interference rate (SINR). The SINR may be obtained by at least one of calculation, measurement and signaling to the allocation function or functionality.

Further advantageous modifications are defined in the dependent claims.

### BRIEF DESCRIPTION OF THE DRAWINGS

In the following, the present invention will be described in greater detail based on an embodiment with reference to the accompanying drawings, in which:

FIGS. 1A and 1B show schematic illustrations of an optimum resource allocation and a limited resource allocation, respectively;

FIGS. 2 to 5 show schematic diagrams indicating allocation and expansion of resource ranges according to the embodiment; and

FIG. 6 shows a schematic flow diagram of a resource allocation procedure according to the embodiment.

### DESCRIPTION OF THE PREFERRED EMBODIMENT

The preferred embodiment will now be described based on an frequency domain packet scheduling (FDPS) for a wireless transmission system.

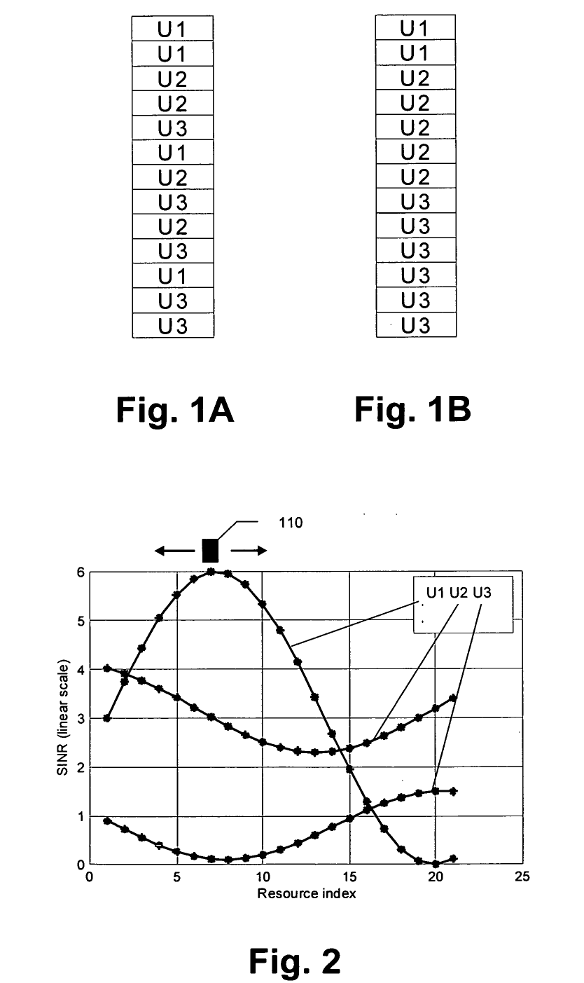

FIG. 1A shows a general illustration of an optimum FDPS where frequency groups or chunks of sub-carriers, each expressed as one rectangular field containing a designation of the user U1 to U3 to whom they are allocated. Thus, the height of each rectangular field of FIG. 1A corresponds to a resource pool or resource unit, e.g. a predetermined frequency range, capable of being separately allocated. The width of each rectangular field may correspond to the scheduling interval.

In the optimum allocation of FIG. 1A, allocation between resource units and users U1 to U3 is not restricted or limited, so that a fairly arbitrary kind of distribution is obtained.

FIG. 1B shows a general illustration of an FDPS with a limitation of giving users only adjacent resource units, e.g., frequency resources. As can be gathered from FIG. 1B, all resource units of the same user are arranged adjacent each other within a respective allocation range. Allocation of resources for packet scheduling in the wireless transmission system is thus performed under the assumption that frequency chunks for a single user will have to be adjacent to each other. This will not provide the optimum scheduling solutions, but will reduce the signaling requirements. Nevertheless, the grouping of resource units (frequency chunks) is still achieved in a near-optimum manner.

The proposed limited allocation procedure could be implemented at a base station device of the wireless transmission system, since scheduling decisions are normally made there. However, if the procedure is to be implemented for another scheduling or allocation system, the location of the resource allocation or scheduling device can be arbitrarily selected, as desired. The procedure itself does not need to be standardized, but system conditions will set the operating conditions for the allocation or scheduling procedure.

FIGS. 2 to 5 show schematic diagrams of the allocation procedure according to the embodiment based on an illustrative example of a transmission quality distribution among resource units and three users U1 to U3. The transmission quality can be derived from a signal-to-noise-plus-interference ratio (SINR) or any other suitable quality-based parameter determined at the resource allocation device, e.g. base station device, based on a received external information or an internal measuring operation.

In particular, FIGS. 2 to 5 indicate three curves expressing a transmission quality distribution (here: SINR distribution) of a linear scale over a resource index which indicates successive resource units. As an example, an SINR=6 is obtained for user U1 at a resource unit of index “7”. At this resource unit “7”, an SINR=3 is obtained for user U2, while an SINR close to zero is obtained for user U3.

In the following, the proposed allocation procedure is described based on FIGS. 2 to 6.

As can be gathered from FIG. 2, user U1 has the highest peak value of the SINR (i.e. SINR=6) and is first selected and an allocation region or range 110 of user U1 is marked with black box or bar on top of the diagram. The allocation range 110 of user U1 is then expanded, e.g. both upwards and downwards as indicated by respective arrows in FIG. 2, as long as user U1 has the highest SINR.

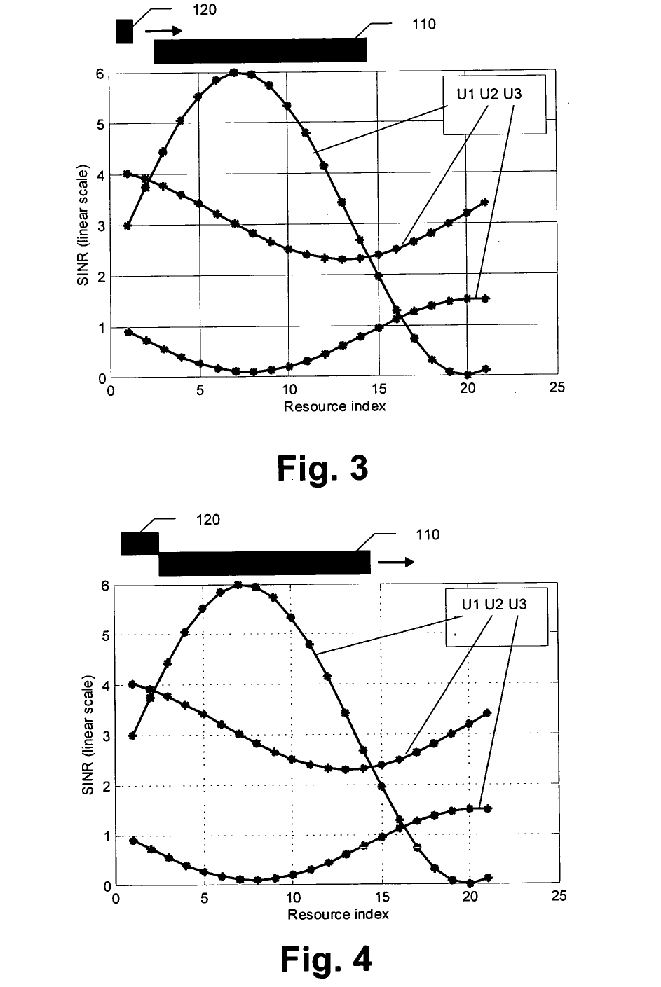

When the SINR of user U1 reaches an SINR value of one of the other users U2 and U3, as indicated in FIG. 3, the allocated resource units (allocation range 110) and SINR values for user U1 are excluded and a new user with the highest SINR is searched. In the present example, user U2 is determined as next strongest user and a new allocation range 120 is allocated to him and expanded. However, this expanding process is limited by the previous allocation range 110 and outer boundaries of available resource units.

Now that allocation for user U2 has been finished and optimized, its allocation range 120 is depicted in FIG. 4, and the allocated SINR values and resource range 120 of user U2 are excluded from the available remaining resources to be allocated.

Now, it may be tried or checked whether the allocation range 110 of user U1 can be further expanded. In the present case of FIG. 4, it can be expanded upwards by two resources indexes, as long as the SINR values of user U1 are higher than those of the remaining user U3. The fact that the SINR values of user U2 are higher in this area is disregarded due to the restriction or limitation that only adjacent resource units can be allocated to an individual user. This leads to a suboptimal allocation.

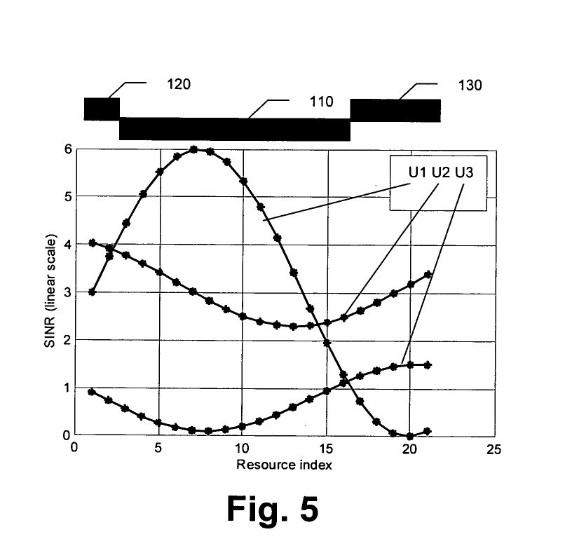

After the additional expansion of the allocation range 110 of user U1 in FIG. 4, the quality curves of the two users U1 and U2, whose resources are already allocated, are disregarded and a new search for maximum SINR is done for user U3 to obtain and expand his allocation range 130, as indicated in FIG. 5.

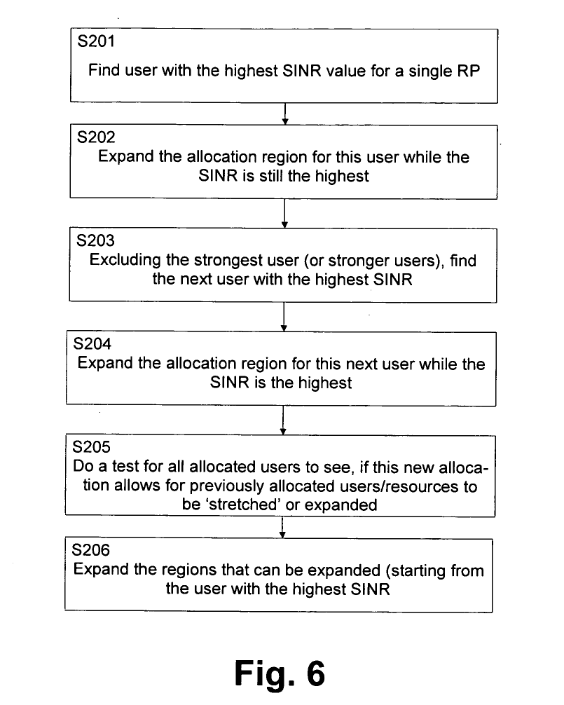

FIG. 6 shows a schematic flow diagram of the above allocation or scheduling procedure, wherein a resource pool (RP) indicates the smallest possible scheduling or resource unit.

In step S201, the user with the highest SINR value for a single RP is searched and its allocation range is started at this RP. Then, in step S202, the allocation region of this user is expanded while the SINR is still the highest among all users. After the borders of the allocation have been detected, the next strongest user with the highest SINR of the remaining non-allocated RPs is searched in step S203. The allocation range of the next strongest user is expanded in step S204 as long as the respective SINR of this user is the highest among the remaining users (still excluding the stronger users, and excluding RPs already allocated).

Now, in step S205, a test may be done for all the users to which allocation ranges have been allocated, to see if this new allocation allows for previously allocated users/resources to be ‘stretched’ or expanded. In step S206 expandable allocation ranges are expanded starting from the strongest user with the highest overall SINR.

If not all available RPs have been allocated, the procedure can be repeated at step S203 until all available RPs have been allocated.

It is noted that the processing flow or procedure of FIG. 6 may be implemented as a software routine configured to control a computer device or processor device provided at the respective allocation device, e.g., base station device.

The proposed resource allocation procedure results in a more spectrally efficient FDPS operation with much smaller computational complexity than optimum methods. It provides high system performance for systems where optimum FDPS can not be supported from a signalling complexity perspective.

In summary, a method, apparatus and computer program product for allocating resource units to a plurality of users in a multiplex transmission system have been described, wherein a transmission quality of available resource units to be allocated is determined for each user, and the resource unit with the highest transmission quality is allocated to the respective strongest user for which the highest transmission quality has been determined. Then, an allocation range of the strongest user is expanded by allocating adjacent resource units to the strongest user as long as the determined transmission quality of the adjacent resource units is still the highest. Resource units with highest transmission quality among the remaining resource units are then allocated to the respective remaining users and their allocation ranges are expanded as long as transmission quality of the adjacent resource units is still the highest among the remaining resource units. Thereby, processing power and complexity of resource allocation can be reduced.

It is noted that the present invention is not restricted to the above embodiment but can be implemented in any multiplex transmission system, where adjacent resource or scheduling units are to be allocated to system users. However, adjacency of the allocated resource or scheduling units is just one of many options for system design to limit the downlink signaling overhead. In particular, the present invention is not intended to be limited to allocation or scheduling of carriers or sub-carriers. It can be used for any transmission system allowing for multiplexing resource units in multiple domains, such as time, space, code, etc. The preferred embodiments may thus vary within the scope of the attached claims.

1. A method, comprising:
determining for each user a transmission quality of available resource units to be allocated in a multiplex transmission system;
allocating a resource unit with a highest transmission quality to a respective strongest user for which the highest transmission quality has been determined;
expanding an allocation range of said strongest user by allocating adjacent resource units to said strongest user as long as the determined transmission quality of said adjacent resource units is still the highest; and
successively allocating the resource units with the highest transmission quality among remaining resource units to respective remaining users and expanding allocation ranges of said remaining users as long as the transmission quality of said adjacent resource units is still the highest transmission quality among the remaining resource units.

2. A method according to claim 1, further comprising:
checking whether the obtained allocation for all the users to which the allocation ranges have been allocated allows for previously allocated allocation ranges to be expanded; and
expanding expandable allocation ranges starting from said strongest user.

3. A method according to claim 1, further comprising:
configuring said resource unit to correspond to a sub-carrier of a multi-carrier transmission system.

4. A method according to claim 1, further comprising:
using said resource allocation for frequency domain packet scheduling in a downlink transmission of a wireless system.

5. A method according to claim 1, further comprising:
determining said transmission quality based on a signal-to-noise-plus-interference rate (SINR).

6. An apparatus configured to allocate resource units to a plurality of users in a multiplex transmission system, said apparatus being further configured to
determine for each user a transmission quality of available resource units to be allocated,
allocate a resource unit with a highest transmission quality to a respective strongest user for which the highest transmission quality has been determined,
expand an allocation range of said strongest user by allocating adjacent resource units to said strongest user as long as the determined transmission quality of said adjacent resource units is still the highest, and
successively allocate the resource units with the highest transmission quality among remaining resource units to respective remaining users and expanding allocation ranges of said remaining users as long as the transmission quality of said adjacent resource units is still the highest transmission quality among the remaining resource units.

7. A base station configured to allocate resource units to a plurality of users in a multiplex transmission system, said base station being further configured to
determine for each user a transmission quality of available resource units to be allocated,
allocate a resource unit with a highest transmission quality to a respective strongest user for which the highest transmission quality has been determined,
expand an allocation range of said strongest user by allocating adjacent resource units to said strongest user as long as the determined transmission quality of said adjacent resource units is still the highest, and
successively allocate the resource units with the highest transmission quality among remaining resource units to respective remaining users and expanding allocation ranges of said remaining users as long as the transmission quality of said adjacent resource units is still the highest transmission quality among the remaining resource units.

8. A computer program embodied on a computer readable medium, the computer program being configured to perform:
determining for each user a transmission quality of available resource units to be allocated in a multiplex transmission system;
allocating a resource unit with a highest transmission quality to a respective strongest user for which the highest transmission quality has been determined;
expanding an allocation range of said strongest user by allocating adjacent resource units to said strongest user as long as the determined transmission quality of said adjacent resource units is still the highest; and
successively allocating the resource units with the highest transmission quality among remaining resource units to respective remaining users and expanding allocation ranges of said remaining users as long as the transmission quality of said adjacent resource units is still the highest transmission quality among the remaining resource units.

9. A computer program according to claim 8, further comprising:
checking whether the obtained allocation for all the users to which the allocation ranges have been allocated allows for previously allocated allocation ranges to be expanded; and
expanding expandable allocation ranges starting from said strongest user.

10. A computer program according to claim 8, further comprising:
configuring said resource unit to correspond to a sub-carrier of a multi-carrier transmission system.

11. A computer program according to claim 8, further comprising:
using said resource allocation for frequency domain packet scheduling in a downlink transmission of a wireless system.

12. A computer program according to claim 8, further comprising:
determining said transmission quality based on a signal-to-noise-plus-interference rate (SINR).
